(19) United States
(12) Patent Application Publication
(10) Pub. No.: US 2014/0260870 A1
(43) Pub. Date: Sep. 18, 2014

(54) VIEWING WINDOW FOR BAND SAW MACHINE

(71) Applicant: OAV EQUIPMENT & TOOLS, INC., TAICHUNG CITY (TW)

(72) Inventors: Chiu-Hsiang LIN, Taichung City (TW); Hung-Chi CHEN, Taichung City (TW)

(73) Assignee: OAV EQUIPMENT & TOOLS, INC., TAICHUNG CITY (TW)

(21) Appl. No.: 13/838,389

(22) Filed: Mar. 15, 2013

(51) Int. Cl. B23D 59/00

(52) U.S. Cl. CPC B23D 59/00
USPC 83/520

(57) ABSTRACT

A viewing window for a band saw machine includes a cover plate and a transparent plate mounted between two locating portions of the cover plate and facing a window opening penetrating through external and internal sides of the cover plate, such that the transparent plate is located between the locating portions of the cover plate. Thus, the transparent plate can be quickly and conveniently assembled on the internal side of the cover plate.

### BACKGROUND OF THE INVENTION

1. Field of the Invention

The present invention relates generally to a band saw machine, and more specifically to a viewing window for a band saw machine that is convenient in assembly.

2. Description of the Related Art

In order to enhance the convenience of inspecting the operation of internal components (such as a band saw blade) of a band saw machine, a transparent plate is usually provided to cover on a window opening of the band saw machine, such that the operating inspection can be performed by an inspector through the transparent plate at any time.

According to the conventional design, the transparent plate is fastened to the external side of the band saw machine by using a plurality of fasteners, such as screws or blind rivets. However, these fasteners are laborious to be secured one by one, and further, these fasteners will be exposed outside to contribute to the disproportionate appearance of the band saw machine after secured. Thus, it is desired to provide an improved design for viewing window structure of the band saw machine.

### SUMMARY OF THE INVENTION

It is one objective of the present invention to provide a viewing window for a band saw machine, which is easy to be assembled and has a smooth appearance.

To achieve this objective of the present invention, the viewing window comprises a cover plate and a transparent plate. The cover plate has an internal side, an external side opposite to the internal side, two opposite locating portions provided at the internal side, and a window opening penetrating through the internal and external sides and located between the two locating portions. The transparent plate is detachably mounted between the two locating portions of the cover plate so as to face the window opening. By this way, the transparent plate is assembled with the cover plate conveniently without using screws or blind rivets, and therefore the transparent plate will not damage the cover plate after assembled, thereby maintaining structural integrity of the band saw machine.

According to the present invention, a plurality of locating members are provided to be respectively inserted through each of locating portions of the cover plate and stopped against the transparent plate for enabling the transparent plate to be abutted against the internal side of the cover plate, thereby keeping the transparent plate in position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a band saw machine equipped with a viewing window according to a first embodiment of the prevent invention;

FIG. 2 is a perspective view of the viewing window according to the first embodiment of the prevent invention;

FIG. 3 is a partially exploded view of the viewing window according to the first embodiment of the prevent invention; and

FIG. 4 is a partially sectional view of the viewing window according to the first embodiment of the prevent invention.

FIG. 5 is a partially sectional view of a viewing window according to a second embodiment of the prevent invention.

### DETAILED DESCRIPTION OF THE INVENTION

As shown in FIG. 1, a band saw machine 10 is equipped with a viewing window 20 in accordance with a first embodiment of the present invention. The band saw machine 10 comprised an upper base 12, a driven wheel (not shown) rotatably mounted in the upper base, a lower base 14 opposite to the upper base 12, a driving wheel (not shown) rotatably mounted in the lower base 14, and a band saw blade 16 running around the driven wheel and the driving wheel. Since the band saw machine 10 is a well-known working machine, the structures of and the relationships among the aforesaid components aren't further detailed description for concise illustration of the present invention.

As shown in FIGS. 2 and 3, the viewing window 20 of the present invention comprises a cover plate 30 and a transparent plate 40.

The cover plate 30 can be, but not limited to, mounted to one side of the upper base 12 according to actual needs. The cover plate 30 includes an internal side 31, an external side 32 opposite to the internal side 31, two opposite locating portions 33 fixed to the internal side 31, and a window opening 34 penetrating through the internal and external sides 31 and 32 and located between the two locating portions 33. As shown in FIGS. 3 and 4, each of the locating portions 33 has a support wall 35 extending from the internal side 31 of the cover plate 30, and two spaced protrusion lugs 36 vertically extending from the support wall 35 towards the window opening 34.

The transparent plate 40, which can be made of acryl, glass or other transparent material, is detachably assembled with the cover plate 30 in such a way that the transparent plate 40 is inserted between the support walls 35 of the two locating portions 33 of the cover plate 30 along an extending direction of the support walls 35 until the transparent plate 40 is located between the internal side 31 of the cover plate 30 and the protrusion lugs 36 of the two locating portions 33 of the cover plate 30, and the transparent plate 40 is aimed at the window opening 34.

To keep the transparent plate 40 in position, a plurality of locating members 50 (such as pins) are provided to be respectively inserted into the a locating hole 37 of each of the protrusion lugs 36 of the cover plate 30 and a taper hole 42 of each corner of the transparent plate 40, such that each of the locating members 50 can push against a periphery wall of each of the taper holes 42 of the transparent plate 40, enabling the transparent plate 40 to be abutted against the internal side 31 of the cover plate 30, as shown in FIG. 4.

Thus, it can be seen that the transparent plate 40 is quick and convenient to be assembled without using screws or blind rivets and located at the internal side 31 of the cover plate 30 after assembled. Even though the locating members 50 are used to fasten the transparent plate 40, the locating members 50 will be hidden inside the upper base 12 of the band saw machine 10. As a result, the viewing window 20 of the present invention can provide a smooth appearance to maintain structural integrity of the band saw machine 10.

To deserve to be mentioned, there is an alternate way to assemble the transparent plate 40 with the cover plate 30 by using the locating members 50. As shown in FIG. 5, the locating hole 37 of the protrusion lug 36 of the cover plate 30 is embodied as a threaded hole, and the transparent plate 40 has a concavity 44 rather than the taper hole 42 of the first embodiment of the present invention, and the locating member 50 is embodied as a bolt, which is threaded into the locating hole 37 of the cover plate 30 and has a distal end stopped against the concavity 44 of the transparent plate 40. By this way, the transparent plate 40 can be pressed against the internal side 31 of the cover plate 30 by the hidden locating members 50.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A viewing window for a band saw machine, comprising:
a cover plate having an internal side, an external side opposite to the internal side, two opposite locating portions provided at the internal side, and a window opening penetrating through the internal and external sides and located between the two locating portions; and
a transparent plate detachably mounted between the two locating portions of the cover plate and facing the window opening.

2. The viewing window as claimed in claim 1, wherein each of the locating portions of the cover plate includes a support wall extending from the internal side of the cover plate, and a protrusion lug vertically extending from the support wall towards the window opening; the transparent plate is located between the support walls of the two locating portions of the cover plate and clamped between the internal side of the cover plate and the protrusion lugs of the two locating portions of the cover plate.

3. The viewing window as claimed in claim 2, further comprising two locating members respectively inserted into a locating hole of each of the protrusion lugs of the cover plate and a taper hole of the transparent plate and pushing against a periphery wall of the taper hole for enabling the transparent plate to be abutted against the internal side of the cover plate.

4. The viewing window as claimed in claim 3, wherein each of the locating members is screwing engaged with one of the locating holes of the cover plate.

5. The viewing window as claimed in claim 2, further comprising two locating members respectively inserted into a locating hole of each of the protrusion lugs of the cover plate and each having a distal end stopped against a concavity of the transparent plate for enabling the transparent plate to be abutted against the internal side of the cover plate.

6. The viewing window as claimed in claim 5, wherein each of the locating members is screwingly engaged with one of the locating holes of the cover plate.
